(19) United States
(12) Patent Application Publication
(10) Pub. No.: US 2020/0167183 A1
(43) Pub. Date: May 28, 2020

(54) ELECTRONIC APPARATUS AND CONTROL METHOD THEREOF

(71) Applicant: SAMSUNG ELECTRONICS CO., LTD., Suwon-si (KR)

(72) Inventors: Kyuyun LEE, Suwon-si (KR); Ilwoo PARK, Suwon-si (KR)

(21) Appl. No.: 16/695,630

(22) Filed: Nov. 26, 2019

(30) Foreign Application Priority Data
Nov. 26, 2018 (KR) 10-2018-0147569

(51) Int. Cl. G06F 9/455; G06F 3/06; G06F 9/50

(52) U.S. Cl. CPC G06F 9/45558; G06F 3/0619; G06F 3/065; G06F 2009/45583; G06F 3/0673; G06F 9/5077; G06F 2009/45562; G06F 3/0665

(57) ABSTRACT

An electronic apparatus including: a communicator comprising communication circuitry; and a processor configured to: allocate containers of a service corresponding to requests of a plurality of external apparatuses received through the communicator to one of a plurality of instances based on the requests, perform a service based on each container to each external apparatus, reallocate a container allocated to a first instance among the plurality of instances to a second instance, and delete the first instance.

### CROSS-REFERENCE TO RELATED APPLICATION

This application is based on and claims priority under 35 U.S.C. § 119 to Korean Patent Application No. 10-2018-0147569 filed on Nov. 26, 2018 in the Korean Intellectual Property Office, the disclosure of which is incorporated by reference herein in its entirety.

### BACKGROUND

### Field

The disclosure relates to an electronic apparatus providing an execution environment of an application to an electronic apparatus through a virtualization platform and a method of controlling the same, and for example to an electronic apparatus managing a system resource used in a virtual platform and a control method thereof.

### Description of Related Art

To compute and process predetermined information in accordance with certain processes, an electronic apparatus basically includes a central processing unit (CPU), a chipset, a memory, and the like electronic components for the computation. Such an electronic apparatus may be variously classified in accordance with what information will be processed and what it is used for. For example, the electronic apparatus may be classified into an information processing apparatus such as a personal computer (PC), a server or the like for processing general information; an image processing apparatus for processing image data; an audio apparatus for audio process; home appliances for miscellaneous household chores; etc. The image processing apparatus may be embodied by a display apparatus that displays processed image data as an image on its own display panel. Such various kinds of electronic apparatuses may serve as a server and a client which can communicate with each other.

The server provides a process environment for executing an application to a plurality of clients. Meanwhile, the clients may be different in an operating system, or may be different in various appended environments where an application is running even though they have the same operating system. The operating system of the server may match an operating system of a client, but there may be a client, an operating system of which does not match the operating system of the server, because many clients are connected to the server. However, it is inefficient in terms of costs, energy, space, management, etc. to prepare servers individually corresponding to the operating systems of the clients. Thus, the server provides the process environments respectively corresponding to various clients having various operating systems.

For example, the server involves a host operating system for driving the server, and a plurality of guest operating systems for generating unit process environments while individually running on the host operating system. The unit process environments provide execution environments for applications based on different guest operating systems, and the plurality of unit process environments are separated from each other in terms of the process. In response to a request of a connected client, the server boots up the guest operating system under the host operating system, and provides the execution environment for the application corresponding to the request of the client under the unit process environment based on the guest operating system. Thus, the server provides the process environment to each individual client in response to requests of various clients having various operating systems and execution environments.

However, when the server provides the unit process environments corresponding to the requests of various clients in this way, a system resource is fragmented in each unit process environment as time goes on. In other words, after the unit process environment is generated and the application is opened in response to the request of the client, the system resource allocated to this unit process environment remains in an allocated state even though the client is disconnected and the application is closed. Because the system resources of the server are allocated as many as the number of generated unit process environments, such a fragmentation phenomenon causes the system resources to be wasted in the server. Accordingly, there may be a need of an electronic apparatus in which such a problem is addressed.

### SUMMARY

Embodiments of the disclosure provide a method and apparatus providing, for example, an execution environment of an application to an electronic apparatus through, for example, a virtualization platform.

According to an example embodiment of the disclosure of the present disclosure, an electronic apparatus is provided, the electronic apparatus including: a communicator comprising communication circuitry; and a processor configured to: allocate containers of a service corresponding to requests of a plurality of external apparatuses received through the communicator to one of a plurality of instances based on the requests, perform a service based on each container to each external apparatus, reallocate a container allocated to a first instance among the plurality of instances to a second instance, and delete the first instance.

The processor may relocate the container to the second instance by backing up a current running image of the container allocated to the first instance and loading the backed-up image to the second instance.

The processor may be configured to: link the external apparatus to the container allocated to the first instance, switch over the link of the external apparatus from the container of the first instance to the container of the second instance based on the reallocation of the container to the second instance, and delete the first instance.

The processor may reallocate the container allocated to the first instance to the second instance based identification that on a use rate of the containers allocated to the first instance is lower than a preset threshold.

The processor may reallocate the container allocated to the first instance to the second instance based on identification that a preset period of time elapses after creating the first instance.

The processor may reallocate the container allocated to the first instance to the second instance based on identification that the containers allocated to the first instance have a lower use rate than those of the second instance.

The processor may reallocate the container allocated to the first instance to the second instance based on identification that the first instance is older than the second instance.

The processor may create a new instance and allocate the container to the new instance based on identification that the container corresponding to the request of the external apparatus is not allocable to the plurality of previously created instances.

The instance may include a unit process to be driven by a second operating system under a first operating system for driving the electronic apparatus, and the container include an application running on the second operating system in the instance.

According to an example embodiment of the present disclosure, a method of controlling an electronic apparatus, is provided, the method including: allocating containers of a service corresponding to requests of a plurality of external apparatuses to one of a plurality of instances based on the requests; performing a service based on each container to each external apparatus; reallocating a container allocated to a first instance among the plurality of instances to a second instance; and deleting the first instance.

### BRIEF DESCRIPTION OF THE DRAWINGS

The above other aspects, features and advantages of certain embodiments of the present disclosure will be more apparent from the following detailed description, taken in conjunction with the accompanying drawings, in which:

FIG. 1 is a diagram illustrating an example electronic apparatus according to an embodiment of the disclosure;

FIG. 2 is a block diagram illustrating an example server according to an embodiment of the disclosure;

FIG. 3 is a flowchart illustrating an example method of controlling a server according to an embodiment of the disclosure;

FIG. 4 is a diagram illustrating an example principle of a virtualization platform driven in a server according to an embodiment of the disclosure;

FIG. 5 a diagram illustrating an example in which a server increases the number of instances according to an embodiment of the disclosure;

FIG. 6 is a diagram illustrating example fragmentation of a container in an instance occurs in a server according to an embodiment of the disclosure;

FIG. 7 is a diagram illustrating an example principle of moving a container between instances so that a server can address the fragmentation phenomenon of FIG. 6 according to an embodiment of the disclosure;

FIG. 8 is a diagram illustrating an example principle that a server moves a container between instances according to an embodiment of the disclosure; and

FIG. 9 is a flowchart illustrating an example of moving a container between instances while a server provides service to a terminal according to an embodiment of the disclosure.

### DETAILED DESCRIPTION

Below, various example embodiments will be described in greater detail with reference to accompanying drawings. Further, the various example embodiments described with reference to the accompanying drawings are not exclusive to each other unless otherwise mentioned, and a plurality of embodiments may be selectively combined within one apparatus. The combination of these plural embodiments may be discretionally selected and applied to realize the present disclosure by a person having an ordinary skill in the art.

In the description of the various example embodiments, an ordinal number used in terms such as a first element, a second element, etc. is employed for describing variety of elements, and the terms are used for distinguishing between one element and another element. Therefore, the elements are not limited by the terms, and the terms are also used simply for explaining the corresponding embodiment without limiting the disclosure.

Further, a term “at least one” among a plurality of elements in the disclosure represents not only all the elements but also each one of the elements, which excludes the other elements or all combinations of the elements.

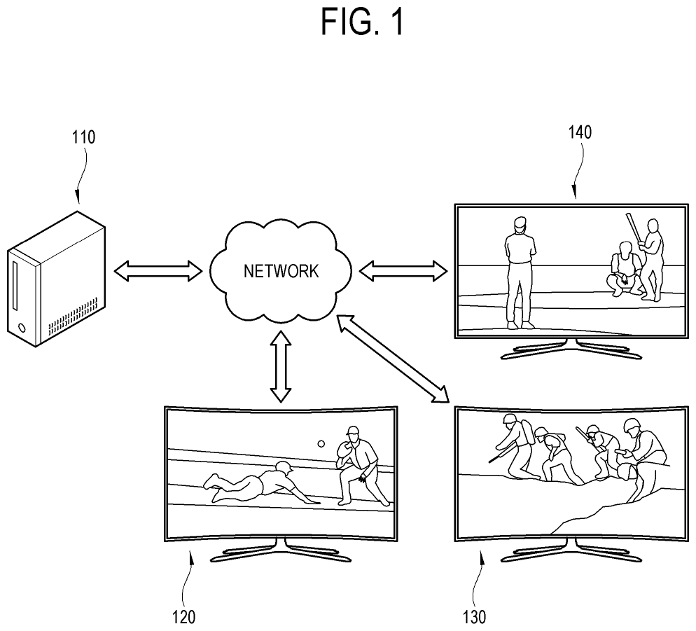

FIG. 1 is a diagram illustrating an example electronic apparatus according to an embodiment of the disclosure.

As shown in FIG. 1, the electronic apparatus according to an embodiment of the disclosure may, for example, be embodied by a server 110, and may connect with a plurality of clients or terminals 120, 130 and 140 through a network for communication. However, the server 110 is merely an example of the electronic apparatus, and the electronic apparatus may, for example, be any host apparatus connectable for communication with various terminals 120, 130 and 140. Connection between the server 110 and the terminals 120, 130 and 140 may include one-to-many connections or the like through, for example, and without limitation, a wide area network, a local area network, a cable, etc. The terminals 120, 130 and 140 may include various apparatuses such as, for example, and without limitation, a TV, a computer, a set-top box, a tablet computer, a portable media player, a wearable device, home appliances, etc. According to an embodiment, the terminals 120, 130 and 140 may be embodied by TVs.

The server 110 may, for example, include a plurality of apparatus groups as well as the single apparatus illustrated in FIG. 1. The server 110 may provide a service environment of a process for various types of programs such as an application to each of the connected terminals 120, 130 and 140. Such a service environment provided by the server 110 may be used in various cases.

For example, the application distributed to the terminals 120, 130 and 140 by a developer may be upgraded through continuous development and management. Likewise, the terminals 120, 130 and 140 developed and produced by manufacturers are also different in device characteristics according to models as technology is developed. For example, the developer may make the application to be executed in state-of-the-art model terminals 120 and 130 at a developing point in time. Further, the developer may consider backward compatibility and manage the application to be executed even in an old-model terminal 140.

However, when the backward compatibility of the application executable in the state-of-the-art model terminals 120 and 130 is not ensured, the application is not executable in the old-model terminal 140. In this case, the server 110 may provide a process environment for executing the application to the terminal 140. For example, when an application for reproducing content of a specific format is not executable in the terminal 140, the terminal 140 may make a request for an operation of making the application reproduce the content to the server 110. The server 110 may reproduce content by, for example, executing the application under a preset process environment in response to the request of the terminal 140, and may transmit, for example, information about a screen, on which that the application reproduces the content, to the terminal 140. The terminal 140 processes the information received from the server 110 and displays the screen of reproducing the content.

However, the terminals 120, 130 and 140 may be respectively driven by different operating systems under different apparatus environments, and therefore the process environments required by the terminals 120, 130 and 140 may be different from one another. Thus, the server 110 may operate a virtualization platform to provide the process environments respectively corresponding to the terminals 120, 130 and 140.

Below, a hardware configuration for the server 110 will be described in greater detail.

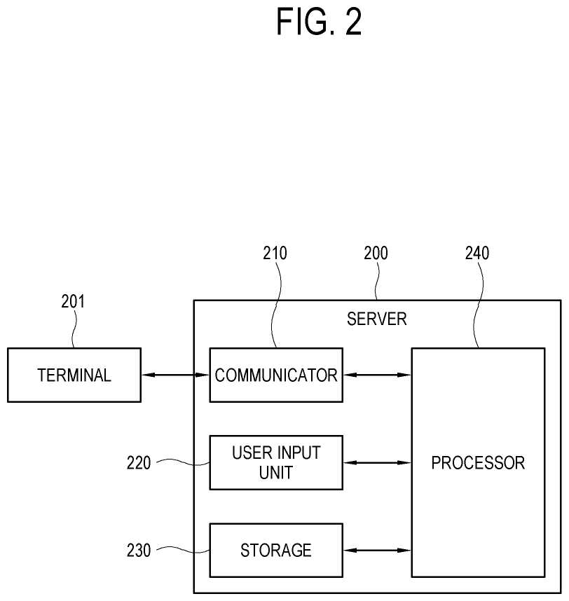

FIG. 2 is a block diagram illustrating an example server according to an embodiment of the disclosure.

As shown in FIG. 2, a server 200 may include a communicator (e.g., including communication circuitry) 210 configured to communicate with one or more terminals 201, a user input unit (e.g., including input circuitry) 220 configured to allow a user to make an input, a storage 230 configured to store data, and a processor (e.g., including processing circuitry) 240 configured to process the data.

The communicator 210 may include, for example, an interactive communication circuit that may include, for example, at least one of elements, such as, for example, and without limitation, communication modules, communication chips, etc. corresponding to various wired and wireless communication protocols. For example, the communicator 210 may be embodied by a wireless communication module including various communication circuitry configured to perform wireless communication with an access point (AP) through Wi-Fi, a local area network (LAN) card connected to a router or a gateway by a wire, or the like. For example, the communicator 120 communicates with the terminal 201 through a network, thereby exchanging a data packet with the terminal 201.

The user input unit 220 may include various input interfaces including various input circuitry through which a user can make an input. The user input unit 220 may be variously configured according to user's control methods, and may for example, and without limitation, include a button, a keyboard, a mouse, a touch pad, a touch screen, a remote controller, etc. provided in the server 200.

The storage 230 may be accessed by the processor 240, and performs operations such as reading, recording, modifying, deleting, updating, etc. for data under control of the processor 240. The storage 230 may include, for example, and without limitation, a flash memory, a hard disk drive (HDD), a solid state drive (SSD), and the like nonvolatile memory in which data is retained regardless of whether power is supplied or not; and a buffer, a random access memory (RAM) and the like volatile memory to which processing data is loaded.

According to an example embodiment, the storage 230 may be configured to store a host operating system, and a plurality of guest operating systems. The host operating system may refer, for example, to an operating system that operates with the hardware of the server 200 and drives the server 200. The guest operating system is driven on the host operating system so as to achieve the virtualization platform. Terms ‘host operating system’ and ‘guest operating system’ are simply provided for convenience to distinguish between such functions, and do not limit the characteristics or type of each operating system.

The processor 240 may include various processing circuitry, such as, for example, and without limitation, one or more hardware processors achieved by a central processing unit (CPU), a dedicated processor, a chipset, a microcontroller, circuit, etc. which may be mounted on a printed circuit board (PCB). The processor 360 may be designed as a system on chip (SoC). The processor 240 may execute the host operating system when the server 200 is booted up, so that the host operating system can control the server 200. Further, the processor 240 may operate the virtualization platform to provide a service for executing the application to the terminal 201.

Below, operation of the processor 240 according to an example embodiment of the disclosure will be described in greater detail.

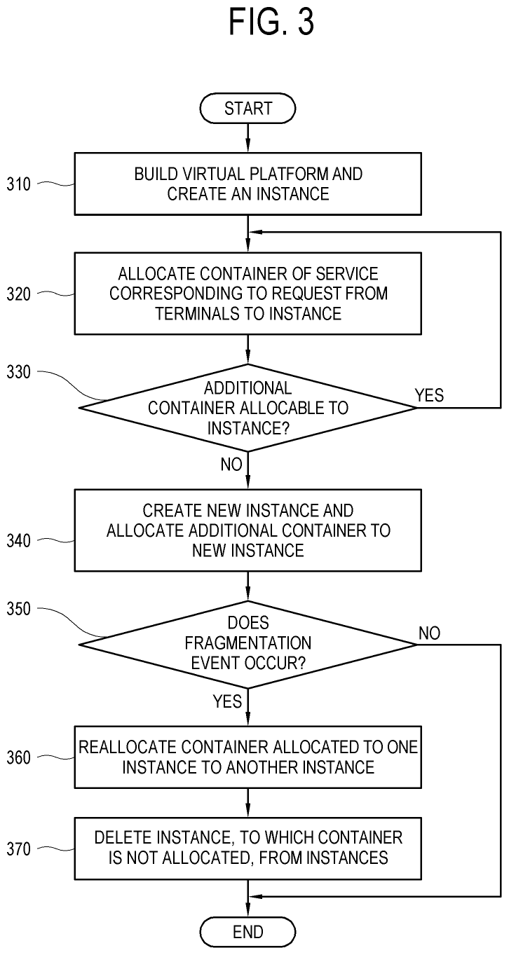

FIG. 3 is a flowchart illustrating an example method of controlling a server according to an embodiment of the disclosure.

As shown in FIG. 3, the following operation may, for example, be performed by the processor of the server.

At operation 310 the server may build a virtual platform and generates an instance. The instance refers to a unit environment related to an execution service for a program embodied using a system resource of the server.

At operation 320, in response to requests from a plurality of terminals, the server may allocate a container of a service corresponding to each request from terminals to an instance, thereby providing a service to each terminal. The container may refer, for example, to a unit of processes where a predetermined application is executed in the instance.

At operation 330 the server identifies whether a container corresponding to a request from an additional terminal is allocable to the instance. Because there is a limit to the number of containers allocable to the instance, the server identifies whether the number of containers is beyond the limit of the instance.

When a container corresponding to a new request is allocable to the instance (“Yes” in operation 330), the server enters the operation 320 and allocates the container to the instance.

On the other hand, when a container corresponding to a new request is not allocable to the instance (“No” in operation 330), at operation 340 the server creates a new instance, and allocates the container to the new instance.

At operation 350 the server identifies whether an event, which shows fragmentation of a container in a plurality of instances, occurs. This event may, for example, be provided as an event having various content and formats in the server. When the fragmentation event does not occur (“No” in operation 350), the server does not perform additional operation.

When the fragmentation event occurs (“Yes” in operation 350), at operation 360 the server reallocates the container allocated to a certain instance among the plurality of instances to another instance. Thus, the certain instance becomes a state that any container is not allocated thereto.

At operation 370 the server may delete the instance, to which any container is not allocated, from among the plurality of instances.

For example, when fragmentation of a container occurs in the plurality of instances, the server performs reallocation by moving the container from a certain instance to a different instance and deletes the certain instance, thereby reducing the number of instances in use. In this manner, when the fragmentation of the container occurs while the plurality of instances are in use, the server according to an embodiment may move the container between the instances and thus addresses a problem of the fragmentation. As the problem of the fragmentation is addressed, the server may reduce the number of instances being used.

In the following example embodiment, the operations described above will be described in greater detail. First, the virtualization platform of the server will be described in greater detail below.

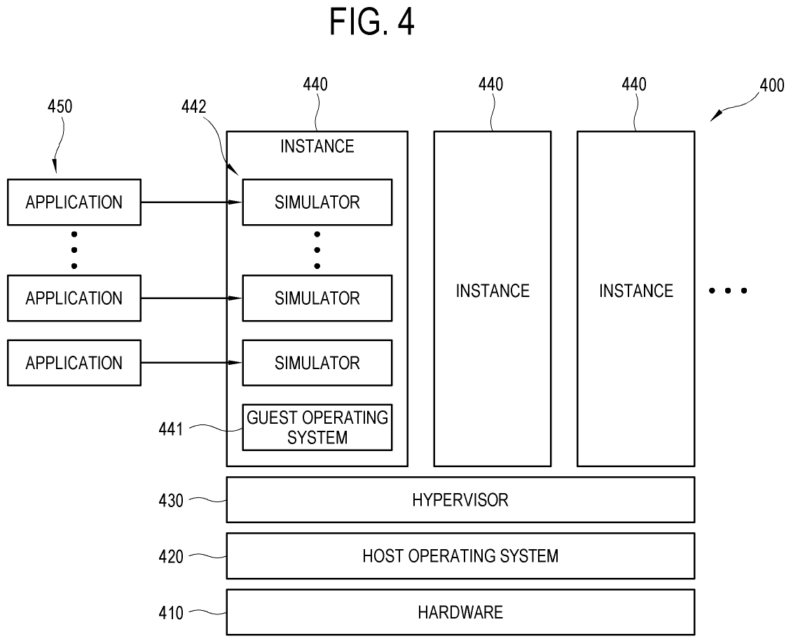

FIG. 4 is a diagram illustrating an example principle of a virtualization platform driven in a server according to an embodiment of the disclosure.

As shown in FIG. 4, a server 400 includes a host operating system 420 configured to operate with hardware 410 to control operation of the hardware 410, and a hypervisor 430 configured to execute one or more instances 440 on the host operating system 420.

The host operating system 420 may manage the hardware 410 of the server 400 and runs various types of software. The host operating system 420 may efficiently allocate, manage and protect the resources of the hardware 410, and may serve to mediate between the hardware 410 and superordinate software. For example, the host operating system 420 may perform various functions such as, for example, and without limitation, process management, interrupt, memory management, a file system, device driver, networking, security, input/output, etc.

The hypervisor 430 may refer, for example, to middleware, which runs on the host operating system 420, and acts as a logic platform for executing a plurality of guest operating systems 441 together on the host operating system 420. Typically, the operating system runs on the hardware in a hierarchical aspect, thereby controlling the resources of the hardware. However, when the virtual platform is embodied, it is difficult in a software aspect that the guest operating system 441 directly runs on the host operating system 420.

Thus, the hypervisor 430 runs on the host operating system 420, thereby virtualizing an environment where the guest operating system 441 can run, and consequently building a platform for running the guest operating system 441 on the host operating system 420. In other words, the hypervisor 430 enables one physical server 400 be divisionally used as many independent virtual server environments.

The instance 440 may refer, for example, to a kind of process environment unit embodied in the hypervisor 430. A plurality of instances 440 may run together on the hypervisor 430. One instance 440 may be driven by one guest operating system 441, and therefore one instance 440 may provide an environment as if one server operates. Therefore, the plurality of instances 440 may include process environments separated from one another.

The instance 440 may refer, for example, to a logically created unit process environment, and is newly created or deleted as needed by the server 400. For example, the server 400 creates the instance 440 by allocating various system resources such as the hardware 410. The instance 440 includes the guest operating system 441 for driving the corresponding instance 440, and a plurality of unit simulators 442 running on the guest operating system 441 to execute a predetermined application 450.

This example embodiment will be described on the assumption that the plurality of instances 440 respectively include the guest operating systems 441. In this example, the guest operating system 441 may be executed when the instance 440 is created, and may be terminated when the instance 440 is terminated. In other words, the guest operating system 441 depends on the instance 440.

However, the virtualization platform is not limited to this example embodiment. For example, the plurality of instances 440 may not individually include the guest operating systems 441, but operate on one guest operating system 441. In this example, the guest operating system 441 needs to have already run before creating the instance 440. Further, the guest operating system 441 is not terminated when other instances 440 is in use even though the instance 440 is terminated. In other words, the guest operating system 441 in this case is independent of the instance 440.

When the instance 440 is created by allocating the system resources of the server 400, the guest operating system 441 and the plurality of simulators 442 may be provided in the instance 440. The number of simulators 442 included in one instance 440 may be previously set. For example, the instance 440 may be created including a previously set number of simulators 442. When one simulator 442 is configured to execute one application, the number of applications 450 executable in one instance 440 is equal to the number of simulators 442 given in one instance 440.

In response to a request from a terminal, the server 400 allocates the application 450 to the simulator 442 in the instance 440, and the simulator 442 executes the application 450. The server 400 transmits information about a screen of executing the application 450 to the terminal, so that the terminal can display the screen of executing the application 450 based on the information. Although the terminal cannot directly execute the application 450, the server 400 gives the process environment for executing the application 450 to the terminal, so that the terminal can indirectly execute the application 450.

For convenience of description and ease of explanation, a unit in which the application 450 is executed by one simulator 442 in one instance 440 may be referred to, for example, as a container. In this example, the maximum number of containers one instance 440 can include corresponds to the number of simulators 442 of the corresponding instance 440. The container, for example, may include the simulator 442 for executing the application 450, and a streaming manager for transmitting reproduction information of the application 450 to the terminal so that a reproduction screen of the application 450 can be provided to the terminal.

After the application 450 is allocated to and executed by the simulator 442, in response to the request of the terminal, when an event such as disconnection of the terminal or the like occurs, the allocation of the application 450 to the simulator 442 is released. The server 400 can allocate another application 450 to the simulator 442 from which the allocation of the application 450 is released.

However, the server 400 does not create and use many instances 440 from an initial stage. This is to cover aspects of not only efficiency in using the resources of the server 400 but also policy on the server 400. Regarding such issues, it will be described below in detail that the server 400 creates the instance 440.

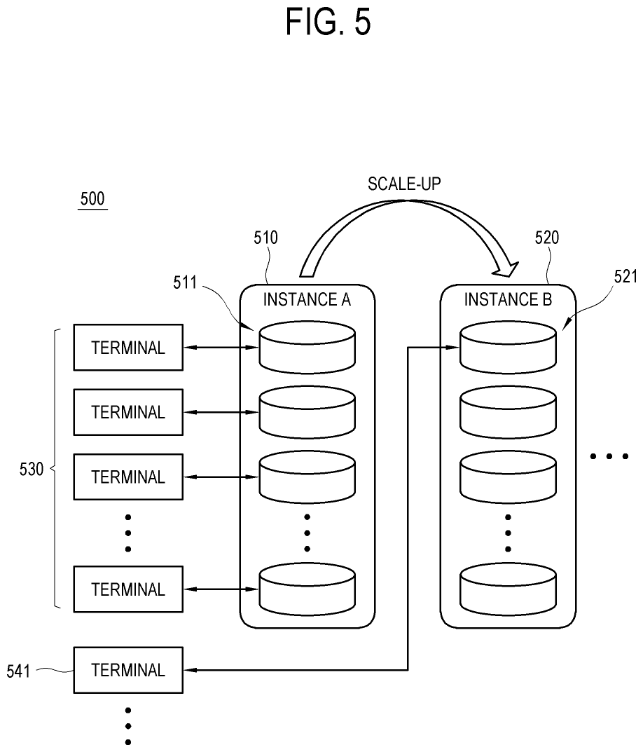

FIG. 5 is a diagram illustrating an example in which a server increases the number of instances according to an embodiment of the disclosure.

As shown in FIG. 5, a server 500 generates an instance A 510 in an initial stage. The instance A 510 includes a preset number of simulators 511, and the simulator 511 in the initial stage is in an idle state that any application is not allocated thereto. In response to a request of each terminal 530, the server 500 executes an application by individually allocating the application to each simulator 511 in the idle state, and provides the execution environment of each application to each matching terminal 530. For convenience and ease of description, the simulator 511 in which the allocated application is running may be referred to, for example, as an allocated state. When the simulator 511 is in the allocated state, the simulator 511 may be also be referred to as a container. When the server 500 receives a request from a new terminal 530, the application is allocated to the simulator 511 having the idle state in the instance A 510.

When the simulators 511 in the instance A 510 are all in the allocated state, e.g., when the simulator 511 having the idle state is not present in the instance A 510, a request may be received from a new terminal 541. In this example, the server 500 may additionally create a new instance, e.g., an instance B 520 because it is not able to drive the application corresponding to the request from the terminal 541 in the instance A 510. This operation may be referred to, for example, as scale-up. The server 500 allocates the application for the terminal 541 to a simulator 521 of the instance B 520 newly created by the scale-up.

When a request from a new terminal is received under the condition that all the simulators 511 and 521 of the instance A 510 and the instance B 520 are in the allocated state, the server 500 performs the scale-up again to create a new instance, and allocates the application to the simulator of the new instance.

Here, the reason why the server 500 does not previously create the plurality of instances 510 and 520 in the initial stage but performs the scale-up only when necessary to newly create the instance 520 is as follows.

All the instances 510 and 520 consume the system resources of the server 500. Typically, the server 500 is likely to be in severe environments for operations such as communication with many terminals, etc. and thus needs to free up system resources if possible, to make operation smooth. Therefore, the server 500 may increase the number of instances 510 and 520 only when necessary, and thus decreases the consumption of the system resources if possible.

Further, it may be assumed that the manager does not directly manage the server 500 but leases and uses the resources of the server 500 from an owner of the server 500. In this case, the manager uses the resources of the server 500 leased from the owner, provides a service to the terminals 530 and 541, and pays the owner for the use of the resources. There may be many references for estimating costs of using the resources of the server 500, and for example the number of instances 510 and 520 may be taken into account. In other words, the cost of using the resource of the server 500 may be estimated in proportion of the number of instances 510 and 520 used for a predetermined period of time.

Therefore, in terms of cost reduction, it is advantageous that the server 500 creates minimal and/or less instances 510 in the initial stage to provide a service, and expands the instances 520 only when necessary.

When the server 500 is disconnected from the terminals 530 and 541 or receives a termination instruction from the terminals 530 and 541, the containers 511 and 521 respectively allocated to the instances 510 and 520 become the idle state.

However, as the scale-up is carried out in response to the requests from many terminals 530 and 541 and the simulators 511 and 521 alternate between the allocated state and the idle state, the fragmentation of the container 511 and 521 inevitably occurs in the instances 510 and 520.

Below, the fragmentation of the container 511 and 521 will be described in greater detail.

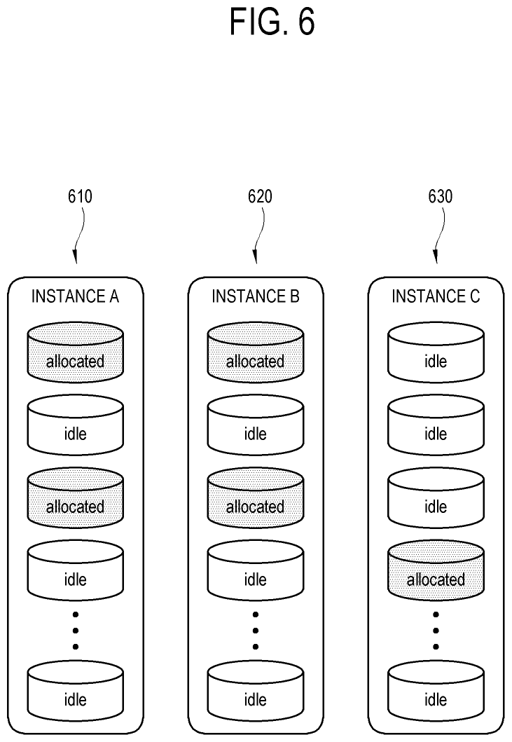

FIG. 6 is a diagram illustrating example fragmentation of a container in an instance occurring in a server according to an embodiment of the disclosure.

As shown in FIG. 6, when a plurality of instances 610, 620 and 630 are present by way of example, each of the instances 610, 620 and 630 may include a plurality of simulators. Each simulator may, for example, be in one between an allocated state and an idle state. The server creates an instance A 610 in an initial stage, and makes the simulator of the instance A 610 become the allocated state in response to a request of each individual terminal the allocated state, thereby allocating the container corresponding to the request to the instance A 610.

When all the simulators in the instance A 610 are in the allocated state, e.g., when it is impossible to allocate the container any more because the instance A 610 reaches a container allocation limit for the containers, the server may additionally create the instance B 620 through scale-up, and allocates an extra container to the instance B 620. When the instance B 620 reaches the container allocation limit, the server may additionally create the instance C 630 through the scale-up, and allocates an extra container to the instance C 630. In this manner, the server can increase the instances 610, 620 and 630 through continuous scale-up.

However, when the communication between the server and the terminal is terminated or a termination instruction for an application is transmitted from the terminal to the server, the server may make the simulator corresponding to the terminal become the idle state. As time goes on with repetition of such operations, the simulator having the idle state and the simulator having the allocated state are mixed in each of the instances 610, 620 and 630 as shown in FIG. 6, e.g., the container may become in the fragmentation state. In FIG. 6, “allocated” indicates the simulator, e.g., the container having the allocated state, and “idle” indicates the simulator having the idle state.

The fragmentation state of the container indicates that many simulators of the instances 610, 620 and 630 are in the idle state, and that more system resources are being used than actually needed for driving the container.

The server may use many ways to identify whether the container has the fragmentation state in the plurality of instances 610, 620 and 630. For example, the server may identify that the container has the fragmentation states when a use rate of the containers in the instances 610, 620 and 630, e.g., the use rate of the simulators having the allocated state among the simulators in the instances 610, 620 and 630 is lower than a preset threshold. The server may identify that the container has the fragmentation states when a predetermined period of time elapses after creating at least one of the instances 610, 620 and 630.

When it is identified that the fragmentation of the container occurs in the plurality of instances 610, 620 and 630, the server may, for example, operate as follows.

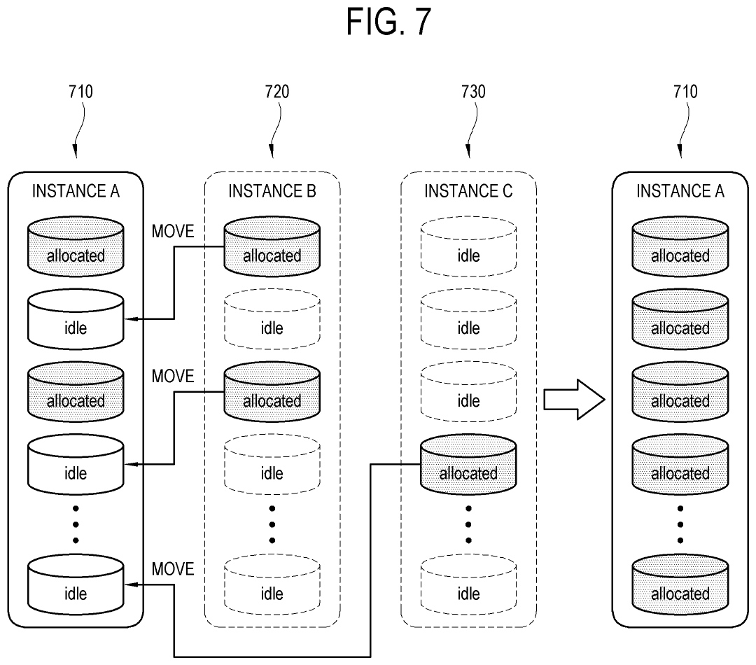

FIG. 7 is a diagram illustrating an example principle of moving a container between instances so that a server can address the fragmentation phenomenon of FIG. 6 according to an embodiment of the disclosure.

As shown in FIG. 7, when it is identified that the fragmentation phenomenon of the container occurs in the plurality of instances 710, 720 and 730, the server may distinguish instances from which the container will be withdrawn and instances to which the withdrawn container will be reallocated among the plurality of instances 710, 720 and 730 based on a preset reference. There are no limits to the number of instances from which the container will be withdrawn and instances to which the withdrawn container will be reallocated.

To this end, there may be various references. For example, the server may identify an older instance or an instance including fewer containers as the instance from which the container will be withdrawn. Further, the server may identify a newer instance or the instance including more containers as the instance to which the withdrawn container will be reallocated. The server may identify a newer instance as the instance from which the container will be withdrawn, and identify an older instance to which the withdrawn container will be reallocated.

In this example embodiment, the server may perform identification to withdraw the containers from the instances B 720 and C 730 and reallocate the withdrawn containers to the instance A 710 among the plurality of instances 710, 720 and 730. The server may perform the reallocation by moving the containers withdrawn from the instances B 720 and C 730 to the simulators having the idle state in the instance A 710. In other words, the server reallocates an application allocated to each simulator of the instances B 720 and C 730 and the running state of the application to the simulator of the idle state in the instance A 710 intact, and runs the application. Therefore, the instance A 710 includes the pre-existing container and the containers moved from the instances B 720 and C 730.

Further, the server may delete the instances B 720 and C 730 in which all the simulators are in the idle state. In this manner, the server may make the containers from the plurality of instances 710, 720 and 730 of the fragmentation move and be collected in the instance A 710, and deletes the instances B 720 and C 730, thereby decreasing the number of instances 710, 720 and 730 being in use.

However, when the fragmentation of the instances 710, 720 and 730 is addressed, the server may not allow a user of a terminal connecting with the container to recognize the movement of the container. Below, detailed operation of the movement of the container among the instances 710, 720 and 730 will be described.

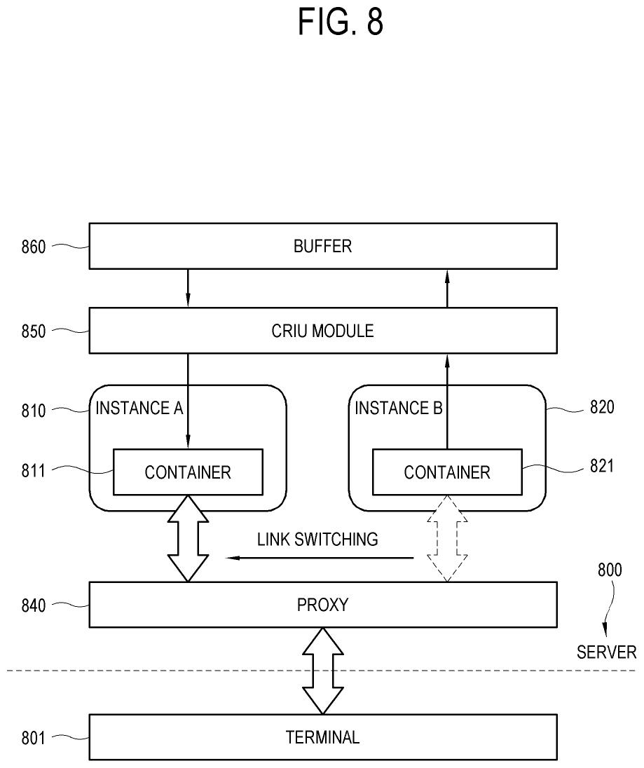

FIG. 8 is a diagram illustrating an example principle that a server moves a container between instances according to an embodiment of the disclosure.

As shown in FIG. 8, a server 800 may for example execute an instance A 810 and an instance B 820, and provides a process environment executed in a container 821 of the instance B 820 to a terminal 801 in response to a request from the terminal 801. In this case, the server 800 identifies that fragmentation occurs in instances 810 and 820, and moves the container moves between the instances 810 and 820 to address the fragmentation. To carry out such operation, the server 800 includes a proxy 840 for matching and connecting the terminal 801 and the container 821 with each other, and a checkpoint/restore in user space (CRIU) module 850 for hibernating and freeing up the containers 811 and 821.

The proxy 840 serves as a kind of router, which respectively links a plurality of containers 821 in the instances 810 and 820 to a plurality of terminals 801, and controls reproduction information about an application running in the container 821 to be transmitted to the matching terminal 801.

The CRIU module 850 freezes the running state of the application in the container 821 as it is. For example, when a predetermined application is running in the container 821, the CRIU module 850 records a running and setting state of the running application in a file, terminates the application, and makes the running and setting state of the application be restored based on a record in the file in the future.

With this structure, the server 800 performs reallocation to address the fragmentation by moving the container 821 from the instance B 820 to the instance A 810 according to the following method. For example, the CRIU module 850 makes an image based on the current running state of the container 821 allocated to the instance B 820, and stores the imaged data in a buffer 860, thereby freezing and retaining the current running state of the container 821.

The server 800 identifies whether the imaged data frozen in the instance A 810 is allocable to the container 811. When the allocation to the container 811 is possible, the CRIU module 850 loads the imaged data stored in the buffer 860 to the instance A 810 and restores the state of the freezing point in time, thereby allocating the container 811 to the instance A 810.

For example, by the operation of addressing the fragmentation, the container 811 is allocated to not the instance B 820 but the instance A 810. Thus, the proxy 840 changes the link of the terminal 801 from the container 821 allocated to the instance B 820 to the container 811 allocated to the instance A 810. Thus, the server 800 can continuously provide the service of the container 811 to the terminal 801 even though the container 821 is moved from the instance B 820 to the instance A 810.

When the movement of the container 821 and the link change of the proxy 840 are completed, the server 800 deletes the container 821 and the instance B 820.

When the fragmentation occurs in the instances 810 and 820, the server 800 makes the same container 811 as the container 821 of the instance B 820 be embodied in the container 821, and switches the link to the terminal 801 over to the container 811 of the instance A 810. Because such link switching is rapidly carried out, a user of the terminal 801 may not recognize discontinuity in the service.

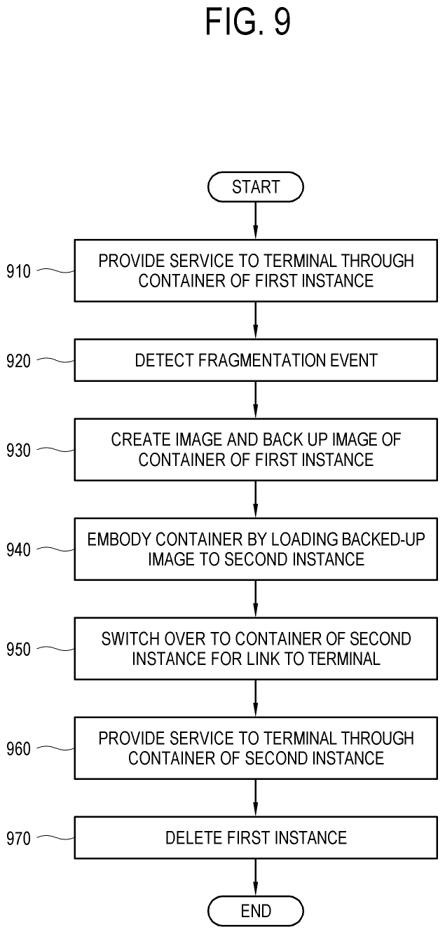

FIG. 9 is a flowchart illustrating an example of moving a container between instances while a server provides service to a terminal according to an embodiment of the disclosure.

As shown in FIG. 9, the following operation may be carried out by a processor of the server.

At operation 910 the server provides the service to the terminal through a container of a first instance.

At operation 920 the server detects a fragmentation event.

At operation 930 the server makes an image based on the container of the first instance at a current point in time, and backs up image data.

At operation 940 the server embodies a container by loading the backed-up image data to the second instance.

At operation 950 the server switches a link to the terminal from the container of the first instance over to a container of a second instance.

At operation 960 the server provides the service to the terminal through the container of the second instance.

At operation 970 the server deletes the first instance. Thus, the server addresses the fragmentation in the instance without discontinuing the service being provided to a user.

The operations of the apparatus described in the foregoing example embodiments may be performed by artificial intelligence provided in the corresponding apparatus. The artificial intelligence may be applied to various general systems by utilizing a machine learning algorithm. An artificial intelligence system may refer, for example, to a computer system with intelligence of a human or being second to a human. In such a system, a machine, an apparatus or a system autonomously performs leaning and identifying and is improved in accuracy of recognition and identification based on accumulated experiences. The artificial intelligence may be based on elementary technology by utilizing machine learning (deep-running) technology and algorithms based on an algorithm of autonomously classifying and learning features of input data, and copying perception, identification and the like functions of a human brain.

The elementary technology may for example include at least one of language comprehension technology for recognizing a language and a text of a human, visual understanding technology for recognizing a thing like a human sense of vision, inference and prediction technology for identifying information and logically making inference and prediction, knowledge representation technology for processing experience information of a human into knowledge data, and motion control technology for controlling a vehicle's automatic driving or a robot's motion.

Linguistic comprehension may refer, for example, to technology of recognizing, applying and processing a human's language or text, and may include natural language processing, machine translation, conversation system, question and answer, voice recognition and synthesis, etc.

Inference and prediction may refer, for example, to technology of identifying information and logically making prediction, and includes knowledge- and probability-based inference, optimized prediction, preference-based plan, recommendation, etc.

Knowledge representation may refer, for example, to technology of automating a human's experience information into knowledge data, and may include knowledge building such as data creation and classification, knowledge management such as data utilization, etc.

The methods according to the foregoing example embodiments may be achieved in the form of a program command that can be implemented in various computers, and recorded in a computer readable medium. Such a computer readable medium may include a program command, a data file, a data structure or the like, or combination thereof. For example, the computer readable medium may be stored in a voltage or nonvolatile storage such as a read only memory (ROM) or the like, regardless of whether it is deletable or rewritable, for example, a RAM, a memory chip, a device or integrated circuit (IC) or the like memory, or an optically or magnetically recordable or machine (e.g., a computer)-readable storage medium, for example, a compact disk (CD), a digital versatile disk (DVD), a magnetic disk, a magnetic tape or the like. It will be appreciated that a memory, which can be included in a mobile terminal, is an example of the machine-readable storage medium suitable for storing a program having instructions for realizing the embodiments. The program command recorded in this storage medium may be specially designed and configured according to the embodiments, or may be publicly known and available to those skilled in the art of computer software.

Although various example embodiments have been illustrated and described, it will be appreciated by those skilled in the art that various changes may be made in these embodiments without departing from the principles and spirit of the disclosure, the scope of which may be set forth, for example, in the appended claims and their equivalents.

What is claimed is:

1. An electronic apparatus comprising:
a communicator comprising communication circuitry; and
a processor configured to:
allocate containers of a service corresponding to requests of a plurality of external apparatuses received through the communicator to one of a plurality of instances based on the requests,
perform a service based on each container to each external apparatus,
reallocate a container allocated to a first instance among the plurality of instances to a second instance, and
delete the first instance.

2. The electronic apparatus according to claim 1, wherein the processor is configured to reallocate the container to the second instance by backing up a current running image of the container allocated to the first instance and loading the backed-up image to the second instance.

3. The electronic apparatus according to claim 2, wherein the processor is configured to:
link the external apparatus to the container allocated to the first instance,
switch the link of the external apparatus from the container of the first instance to the container of the second instance based on the reallocation of the container to the second instance, and
delete the first instance.

4. The electronic apparatus according to claim 1, wherein the processor is configured to reallocate the container allocated to the first instance to the second instance based identification that on a use rate of the containers allocated to the first instance is less than a preset threshold.

5. The electronic apparatus according to claim 1, wherein the processor is configured to reallocate the container allocated to the first instance to the second instance based on identification that a preset period of time elapses after creating the first instance.

6. The electronic apparatus according to claim 1, wherein the processor is configured to reallocate the container allocated to the first instance to the second instance based on identification that the containers allocated to the first instance have a lower use rate than a use rate of containers allocated to the second instance.

7. The electronic apparatus according to claim 1, wherein the processor is configured to reallocate the container allocated to the first instance to the second instance based on identification that the first instance is older than the second instance.

8. The electronic apparatus according to claim 1, wherein the processor is configured to create a new instance and to allocate the container to the new instance based on identification that the container corresponding to the request of the external apparatus is not allocable to the plurality of previously created instances.

9. The electronic apparatus according to claim 1, wherein
the instance comprises a unit process configured to be driven by a second operating system under a first operating system for driving the electronic apparatus, and
the container comprises an application running on the second operating system in the instance.

10. A method of controlling an electronic apparatus, comprising:
allocating containers of a service corresponding to requests of a plurality of external apparatuses to one of a plurality of instances based on the requests;
performing a service based on each container to each external apparatus;
reallocating a container allocated to a first instance among the plurality of instances to a second instance; and
deleting the first instance.

11. The method according to claim 10, wherein the container is reallocated to the second instance by backing up a current running image of the container allocated to the first instance and loading the backed-up image to the second instance.

12. The method according to claim 11, further comprising:
linking the external apparatus to the container allocated to the first instance,
switching the link of the external apparatus from the container of the first instance to the container of the second instance based on the reallocation of the container to the second instance, and
deleting the first instance.

13. The method according to claim 10, further comprising reallocating the container allocated to the first instance to the second instance based identification that on a use rate of the containers allocated to the first instance is less than a preset threshold.

14. The method according to claim 10, further comprising reallocating the container allocated to the first instance to the second instance based on identification that a preset period of time elapses after creating the first instance.

15. The method according to claim 10, further comprising reallocating the container allocated to the first instance to the second instance based on identification that the containers allocated to the first instance have a lower use rate than a use rate of containers allocated to the second instance.

16. The method according to claim 10, further comprising reallocating the container allocated to the first instance to the second instance based on identification that the first instance is older than the second instance.

17. The method according to claim 10, further comprising creating a new instance and allocating the container to the new instance based on identification that the container corresponding to the request of the external apparatus is not allocable to the plurality of previously created instances.

18. The method according to claim 10, wherein
the instance comprises a unit environment related to a running service of a program configured to be driven by a second operating system under a first operating system for driving the electronic apparatus, and
the container comprises an application running on the second operating system in the instance.
